(19) United States
(12) Patent Application Publication
(10) Pub. No.: US 2019/0008147 A1
(43) Pub. Date: Jan. 10, 2019

(54) COMPOSITION CONTAINING 1,2-DIBROMO-2,4-DICYANOBUTANE (DBDCB) AND AT LEAST ONE ORGANIC ACID AND/OR THE DERIVATIVES THEREOF

(71) Applicant: LANXESS Deutschland GmbH, Cologne (DE)

(72) Inventors: Peter WACHTLER, Krefeld (DE); Tanja GERHARZ, Solingen (DE)

(73) Assignee: LANXESS Deutschland GmbH, Cologne (DE)

(21) Appl. No.: 15/752,427

(22) PCT Filed: Aug. 23, 2016
(86) PCT No.: PCT/EP2016/069844

§ 371 Date: Feb. 13, 2018

(30) Foreign Application Priority Data
Aug. 24, 2015 (EP) 15182206.1

(51) Int. Cl. A01N 37/34; A01N 37/10; A01N 37/02; A01N 65/00

(52) U.S. Cl. CPC A01N 37/34; A01N 37/10; A01N 43/80; A01N 65/00; A01N 2300/00; A01N 37/02

(57) ABSTRACT

A composition, characterized in that it comprises 1,2-dibromo-2,4-dicyanobutane (DBDCB) and at least one organic acid and/or the derivatives thereof.

The present invention relates to compositions comprising 1,2-dibromo-2,4-dicyanobutane (DBDCB) and at least one organic acid and/or the derivatives thereof, to processes for producing the compositions according to the invention and to the use thereof for protection of industrial materials from attack and destruction by microorganisms and also to industrial materials comprising the compositions according to the invention.

1,2-Dibromo-2,4-dicyanobutane (DBDCB, “Tektamer 38”) is a biocidal active substance which has long been used in practice for producing antimicrobial formulations for controlling material-destroying bacteria, fungi or yeasts especially in industrial preparations. This active substance in principle exhibits a broad antimicrobial effect against microorganisms such as bacteria, fungi or yeasts and has the advantage of good compatibility in many products requiring protection. However, the activity is not always satisfactory in some usages owing to the relatively high lipophilicity of DBDCB. Therefore, to achieve good preservation, such cases require usage concentrations that are in turn, on account of the sensitizing potential of DBDCB in higher concentrations, too high in certain usages for reasons of skin compatibility for example. There is accordingly a need to be able to utilize the broad antimicrobial activity of DBDCB even when using relatively small amounts.

A further class of biocidal active substances having good antimicrobial activity against material-destroying bacteria, molds and yeasts are organic acids such as, for example, benzoic acid, lactic acid, salicylic acid, sorbic acid or citric acid and also the respective derivatives thereof, which are used especially in the cosmetics industry. However, such organic acids exhibit a weaker antimicrobial activity in comparison with the biocides used as standard in industrial preservation and must therefore, if used as individual product, be used in amounts which can lead to unwanted property changes (e.g. thickenings, discolorations, changes in odor) in the products requiring protection. A further disadvantage arising from the high usage amounts is the resulting increased costs. The requirements of a universally employable biocide product are thus not fulfilled in all usages by organic acids as the sole biocidal active substance.

EP 162107681 describes compositions comprising DBDCB and the biocide 2-methyl-3-Isothiazolin-3-one (MIT). Since MIT exhibits a strongly sensitizing potential, such compositions comprising DBDC8 and MIT are not suitable either for those usages in which improved skin compatibility is particularly important.

EP 0098410B1 describes compositions comprising DBDCB and the biocide 1,2-benzisothiazolin-3-one (BIT). Since BIT also exhibits a strongly sensitizing potential, the same problem arises as described under EP 162107681.

U.S. Pat. No. 5,034,405A describes compositions comprising DBDCB and the biocide mixture 5-chloro-2-methyl-4-isothiazolin-3-one/2-methyl-4-isothiazolin-3-one (CMIT/MIT). Since the active substance mixture CMIT/MIT on its part also exhibits a strongly sensitizing potential, these compositions are not a solution either with respect to providing a composition having improved skin compatibility.

Therefore, there continues to be a need for improved product combinations in order to improve the inherent antimicrobial activity spectrum of DBDCB and of organic acids such as, for example, benzoic acid, lactic acid, salicylic acid, sorbic acid or citric acid and also the respective derivatives thereof. Furthermore, it is intended that there be provided a product combination which is more skin compatible in comparison with DBDCB as the sole biocidal active substance.

It has now been found that, surprisingly, compositions based on 1,2-dibromo-2,4-dicyanobutane (DBDCB) and at least one organic acid and/or the derivatives thereof can overcome the disadvantages of the respective individual components in an advantageous manner.

The compositions according to the invention are moreover surprisingly notable in that they exhibit an unexpectedly high, synergistic activity enhancement in specific mixture ratios. Consequently, the usage concentrations required for protection of industrial products in the case of the compositions according to the invention may be reduced compared to the required concentrations in the case of the respective individual active substances. This is extremely advantageous from an economic, environmental and use-related perspective, since, as a result, the desired improvement in skin compatibility when using DBDCB can be achieved without loss of quality of preservation.

The present invention therefore provides compositions which are characterized in that they comprise 1,2-dibromo-2,4-dicyanobutane (DBDCB) and at least one organic acid and/or the derivatives thereof.

The relative ratios of DBDCB to the at least one organic acid and/or the derivatives thereof in the compositions according to the invention may vary over a wide range. Preferably, the weight ratio of DBDCB to the at least one organic acid and/or the derivatives thereof in the composition is 99:1 to 1:99, particularly preferably 9:1 to 1.9.

Furthermore, preferably at least 60 wt %, particularly preferably at least 80 wt %, very particularly preferably at least 90 wt %, yet further preferably at least 95 wt %, of the sum of DBDCB and the at least one organic acid and/or the derivatives thereof, based on the total weight of the composition according to the invention, are present in dissolved form in the compositions according to the invention.

Organic Acids

The compositions according to the invention preferably comprise at least one organic acid and/or the derivatives thereof selected from the group consisting of mono- and polycarboxylic acids and the derivatives thereof, particularly preferably at least one organic acid and/or the derivatives thereof selected from the group consisting of benzoic acid, lactic acid, salicylic acid, sorbic acid and citric acid and the derivatives thereof.

Preferably, the derivatives of the at least one organic acid are alkali metal salts.

Preferably, the alkali metal salts of the at least one organic acid are selected from the group consisting of sodium, potassium and lithium salts.

In a preferred embodiment, the composition according to the invention comprises benzoic acid and/or the derivatives thereof as the at least one organic acid and/or the derivatives thereof.

Preferably, the weight ratio of DBDCB to benzoic acid and/or the derivatives thereof as the at least one organic acid and/or the derivatives thereof in the composition according to the invention is 9:1 to 1:9, particularly preferably 9:1 to 6:4 or 4:6 to 2:8.

In a further preferred embodiment, the composition according to the invention comprises lactic acid and/or the derivatives thereof as the at least one organic acid and/or the derivatives thereof.

Preferably, the weight ratio of DBDCB to lactic acid and/or the derivatives thereof as the at least one organic acid and/or the derivatives thereof in the composition according to the invention is 9:1 to 1:9, particularly preferably 9:1 to 6:4.

In another preferred embodiment, the composition according to the invention comprises salicylic acid and/or the derivatives thereof as the at least one organic acid and/or the derivatives thereof.

Preferably, the weight ratio of DBDCB to salicylic acid and/or the derivatives thereof as the at least one organic acid and/or the derivatives thereof in the composition is 9:1 to 1:9, particularly preferably 9:1 to 3:7, very particularly preferably 9:1 to 6:4 or 5:4 to 3:7.

Particularly preferably, salicylic acid and/or the derivatives thereof as the at least one organic acid and/or the derivatives thereof in the composition according to the invention is used in the form of a composition SA which comprises at least 10 wt %, preferably at least 30 wt %, particularly preferably at least 50 wt %, very particularly preferably at least 75 wt %, based on the total weight of the composition SA, of salicylic acid and/or the derivatives thereof.

In a very particularly preferred embodiment, the composition SA is a Salix alba extract.

Salix alba extract is an extract from the bark of the white willow (Salix alba), which is a plant species in the willow genus from the willow family (Salicaceae). A Salix alba extract is obtained from the bark of the white willow by methods known to those skilled in the art, preferably by extraction, particularly preferably by extraction with water and/or ethanol.

In another preferred embodiment, the composition according to the invention comprises citric acid and/or the derivatives thereof as the at least one organic acid and/or the derivatives thereof.

Preferably, the weight ratio of DBDCB to citric acid and/or the derivatives thereof as the at least one organic acid and/or the derivatives thereof in the composition according to the invention is 9:1 to 1:9, particularly preferably 9:1 to 5:5, very particularly preferably 9:1 to 7:3.

Further Biocidal Active Substances

Besides DBDCB and the at least one organic acid and/or the derivatives thereof, the compositions according to the invention can comprise additionally no further biocidal active substance or at least one further biocidal active substance.

Preferable further biocidal active substances include the following active substances:
1,2-benzisothiazol-3(2H)-one (BIT)
benzyl alcohol
benzyl hemiformal
2-bromo-2-nitropropane-1,3-diol (Bronopol)
5-chloro-2-methyl-4-isothiazolin-3-one/2-methyl-4-isothiazolin-3-one (CMIT/MIT)
2,2-dibromo-3-nitriliopropionamide (DBNPA)
diazolidinyl urea
3,3-dimethylol-5,5-dimethylhydantoin (DMDMH)
dichlorobenzyl alcohol
didecyldimethylammonium chloride
dimethylolhydantoin
dodecylguanidine hydrochloride
imidazolidinyl urea
iodopropargyl butylcarbamate (IPBC)
2-n-octylisothiazolin-3-one (OIT)
phenoxyethanol
phenoxypropanol
phenylethyl alcohol
o-phenylphenol (OPP)
poly(hexamethylenebiguanide) hydrochloride (PHMB)
tetramethylolacetylene diurea (TMAD)

The weight ratio of the at least one further biocidal active substance to the sum of DBDCB and the at least one organic acid and/or the derivatives thereof is preferably 1:40 to 1:1.

In the compositions according to the invention, the sum of the wt % ages of DBDCB and of the at least one organic acid and/or the derivatives thereof and of the additionally no further biocidal active substance or at least one further biocidal active substance may be varied over a wide range.

The sum of DBDCB, of the at least one organic acid and/or the derivatives thereof and of the additionally no further biocidal active substance or at least one further biocidal active substance is preferably 1 to 80 wt %, particularly preferably 5 to 60 wt %, based on the total weight of the composition according to the invention.

Further Added Substances

The composition according to the invention may comprise no further added substance or at least one further added substance.

The application of the composition according to the invention may, depending on its respective physical and/or chemical properties/the specific requirements of the preservation problem to be solved, be effected either separately in the form of a metered addition of the individual active substances, wherein individual adjustment of the concentration ratio may be undertaken depending on the preservation problem at issue, or metered addition of the composition according to the invention may be effected as a finished formulation.

Preferably, the compositions according to the invention are present as finished formulations.

The compositions according to the invention are particularly preferably present in the form of a formulation which is a solution, a dispersion, an emulsion, a suspension, a powder, a foam, a paste, a granulate, aerosol or a microencapsulated form in polymeric substances.

The compositions according to the invention may thus further comprise or not comprise at least one auxiliary suitable for producing a formulation as a further added substance.

The composition according to the invention preferably comprises at least one auxiliary as a further added substance.

The composition according to the invention preferably comprises at least one auxiliary selected from the group consisting of surface-active substances, wetting agents, emulsifiers, dispersants, stabilizers, adhesives, thickeners, spreading agents, organic solvents, fragrances, colorants, antidusting agents, buffering substances, buffer systems, pH regulators, solid carriers and water.

In a preferred composition according to the invention in which a plurality of auxiliaries from the abovementioned group are selected, these auxiliaries are distinct from one another.

The preferred auxiliaries of the present invention are more particularly elucidated by way of example hereinbelow
Surface-active substances, for example surfactants. Surfactants may for example be nonionic, cationic and amphoteric surfactants, preferably anionic surfactants. Suitable anionic surfactants are for example alkyl sulfates, alkyl ether sulfates, alkylarylsulfonates, alkyl succinates, alkyl sulfosuccinates, N-alkoyl sarcosinates, acyl taurates, acyl isethionates, alkyl phosphates, alkyl ether phosphates, alkyl ether carboxylates, alpha-olefinsulfonates, in particular the alkali metal and alkaline earth metal salts, for example sodium, potassium, magnesium, calcium, and ammonium and triethanolamine salts. The alkyl ether sulfates, alkyl ether phosphates and alkyl ether carboxylates may each have for example between 1 to 10 ethylene oxide or propylene oxide units, preferably 1 to 3 ethylene oxide units. Suitable are for example sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate.
Wetting agents, for example alkali metal, alkaline earth metal and ammonium salts of aromatic sulfonic acids, for example ligno-, phenol-, naphthalene- and dibutylnaphthalenesulfonic acid, and of fatty acids, alkylsulfonates and alkylarylsulfonates, alkyl and lauryl ethers and fatty alcohol sulfates and also salts of sulfated hexa-, hepta- and octadecanols or fatty alcohol glycol ethers, condensation products of sulfonated naphthalene and its derivatives with formaldehyde, condensation products of naphthalene and of naphthalenesulfonic acids with phenol and formaldehyde, polyoxyethylene octylphenol ether, ethoxylated isooctyl-, octyl- or nonylphenol, alkylphenol or tributylphenyl polyglycol ethers, alkylaryl polyether alcohols, isotridecyl alcohol, fatty alcohol ethylene oxide condensates, ethoxylated castor oil, polyoxyethylene alkyl ethers or polyoxypropylene, lauryl alcohol polyglycol ether acetate, sorbitol ester, lignosulfite waste liquors or methylcellulose.
Emulsifiers, for example sodium, potassium and ammonium salts of straight-chain aliphatic carboxylic acids of chain length C₁₂-C₂₀, sodium hydroxyoctadecanesulfonate, sodium, potassium and ammonium salts of hydroxy fatty acids of chain length C₁₂-C₂₀ and the sulfation or acetylation products thereof, alkyl sulfates, also as triethanolamine salts, alkyl-(C₁₀-C₂₀)-sulfonates, alkyl-(C₁₀-C₂₀)-arylsulfonates, dimethyldialkyl-(C₈-C₁₈)-ammonium chloride, acyl, alkyl, oleyl and alkylaryl oxethylates and the sulfation products thereof, alkali metal salts of sulfosuccinic acid esters with aliphatic saturated monohydric alcohols of chain length C₄-C₁₆, sulfosuccinic acid 4-ester with polyethylene glycol ethers of monohydric aliphatic alcohols of chain length C₁₀-C₁₂ (disodium salt), sulfosuccinic acid 4-ester with polyethylene glycol nonylphenyl ether (disodium salt), sulfosuccinic acid bis-cyclohexyl ester (sodium salt), lignosulfonic acid and the calcium, magnesium, sodium and ammonium salts thereof, polyoxyethylene sorbitan monooleate with 20 ethylene oxide groups, uric acids, hydrogenated and dehydrogenated uric acids, and alkali metal salts thereof, dodecylated diphenyl ether disulfonic acid sodium, and copolymers of ethylene oxide and propylene oxide with a minimum content of 10 wt % of ethylene oxide. Preferably used emulsifiers are: sodium lauryl sulfate, sodium lauryl ether sulfate, ethoxylated (3 ethylene oxide groups); the polyethylene glycol (4-20)ethers of oleyl alcohol, and the polyethene oxide (4-14)ethers of nonylphenol.
Dispersants, for example alkylphenol polyglycol ethers.
Stabilizers, for example cellulose and cellulose derivatives.
Adhesives and thickeners, for example carboxymethylcellulose, natural and synthetic pulverulent, granular or latex-like polymers are employed, such as gum Arabic, polyvinyl alcohol, polyvinyl acetate and natural phospholipids, such as cephalins and lecithins and
synthetic phospholipid and also mineral or vegetable oils.
Spreading agents, for example isopropyl myristate, polyoxyethylene nonylphenyl ether and polyoxyethylene laurylphenyl ether.
Organic solvents, for example mono- or polyhydric alcohols, glycols, esters, ketones or hydrocarbons. Preferred organic solvents are paraffins, mineral and vegetable oils, butanol and glycol and also the ethers and esters thereof, ketones such as acetone, methyl ethyl ketone, methyl isobutyl ketone or cyclohexanone, particularly preferably glycols, very particularly preferably 1,2-propanediol.
Fragrances, colorants, such as inorganic pigments, for example iron oxide, titanium oxide, Prussian blue, and organic colorants, such as alizarin, azo and metallophthalocyanine colorants, and trace nutrients such as salts of iron, manganese, boron, copper, cobalt, molybdenum and zinc.
Buffering substances, buffer systems or pH regulators. The compositions according to the invention may respectively comprise for example 0.01 to 10, preferably 0.1 to 5, wt % of buffering substances, buffer systems or pH regulators.
Solid carriers, for example natural rock flours, such as kaolins, days, talc, chalk, quartz, attapulgite, montmorillonite or diatomaceous earth, and synthetic rock flours, such as finely divided silica, aluminum oxide and silicates. Suitable solid carriers, in particular for granulates, include for example: crushed and fractionated natural rocks, such as calcite, marble, pumice, sepiolite and dolomite, and also synthetic granulates made of inorganic and organic flours and also granulates made of organic material such as sawdust, coconut shells, corn cobs and tobacco stalks.
Water.

Preferably, the composition according to the invention comprises at least one organic solvent as auxiliary, particularly preferably at least one glycol.

The composition according to the invention preferably comprises 20-99 wt %, particularly preferably 40 to 95 wt %, of at least one further added substance, based on the total weight of the composition according to the invention.

A preferred composition according to the invention comprises 10-30 wt % of DBDCB, 10-30 wt % of Salix alba extract comprising at least 10 wt %, preferably at least 30 wt %, particularly preferably at least 50 wt %, very particularly preferably at least 75 wt %, of salicylic acid and/or the derivatives thereof, based on the total weight of the Salix alba extract, and 40-80 wt % of a glycol, preferably 1,2-propanediol.

Production

The invention further provides a process for producing the composition according to the invention, characterized in that DBDCB and the at least one organic acid and/or the derivatives thereof are mixed together, optionally with addition of at least one further biocidal active substance and optionally with addition of at least one further added substance.

A preferred production of the composition according to the invention is characterized in that DBDCB and the at least one organic acid and/or the derivatives thereof and also at least one further added substance, preferably at least one solvent, are mixed together.

The above indications concerning the further biocidal active substances, the added substances and auxiliaries apply analogously for the production according to the invention.

Use

The invention further provides for the use of the compositions according to the invention for protection of industrial materials from attack and/or destruction by microorganisms.

Preferred industrial materials which are to be protected from attack and/or destruction by microorganisms by use of the compositions according to the invention are water-containing functional liquids and water-containing industrial products.

Mention may be made, by way of example but not by way of limitation, of use in the following industrial materials:
coatings, paints, renders and other coating systems
starch solutions and starch slurries or other starch-based products such as, for example, printing thickeners
slurries of other raw materials such as color pigments (e.g. iron oxide pigments, carbon black pigments, titanium dioxide pigments) or slurries of inorganic filers and pigments such as kaolin, calcium carbonate, gypsum, bentonite, magnesium silicates, smectite or talc.
chemical products for building and construction such as concrete additives, for example based on molasses, lignin sulfonate or polyacrylates, bitumen emulsion or sealing compounds
glues or adhesives based on known raw materials of animal, plant or synthetic origin
polymer dispersions based on for example polyacrylate, polystyrene acrylate, styrene-butadiene, polyvinyl acetate and others
dishwashing liquids, liquid laundry detergents and household cleaning agents for industrial and domestic use
mineral oils and mineral oil products (e.g. diesel fuels)
cooling lubricant concentrates for metal processing based on mineral oil-containing, semisynthetic or synthetic concentrates
auxiliaries for the leather, textile or photochemical industry
chemical industry precursors and intermediates, for example in colorant production and storage
solvent- or water-borne inks
wax and clay emulsions

Preferably, the compositions according to the invention are used for protection of detergents and surface-active substances which are preferably present in dishwashing liquids, liquid laundry detergents, household cleaning agents and other cleaning agents.

The use concentrations of the inventive mixture to be used in accordance with the invention depend on the species and the incidence of the microorganisms to be controlled, on the initial microbial load, on the expected storage period of the products to be protected and on the microbiological susceptibility of the components present in the end products. The optimum usage amount may be determined in a simple fashion in a manner sufficiently familiar to those skilled in the art by preliminary experiments and test series in the laboratory.

The compositions according to the invention are preferably employed for protection of industrial materials in amounts in the range from 0.01 to 5 wt %, particularly preferably from 0.05 to 1.0 wt %, based on the weight of the material to be protected.

The invention further provides industrial materials that have been treated with the composition according to the invention.

The present invention further provides industrial materials comprising a composition according to the invention.

Preferably, the industrial materials comprising the composition according to the invention comprise it in amounts in the range from 0.01 to 5 wt %, particularly preferably from 0.05 to 1.0 wt %, based on the weight of the industrial material.

The above industrial materials recited by way of example apply analogously for the industrial materials.

Preferably, the present invention provides, as industrial materials, dishwashing liquids, liquid laundry detergents and household cleaning agents which comprise the composition according to the invention.

The composition according to the invention is active against a very wide variety of microorganisms, for example bacteria, molds, yeasts and slime organisms.

Mention may be made, by way of example but not by way of limitation, of the following species against which the composition according to the invention shows activity:

Bacteria:

Alcaligenes such as Alcaligenes faecalis, Bacillus such as Bacillus subtilis, Enterobacter such as Enterobacter aerogenes, Escherichia such as Escherichia coli, Proteus such as Proteus vulgaris, Pseudomonas such as Pseudomonas aeruginosa or Pseudomonas fluorescens, Serratia such as Serratia marescens, Staphylococcus such as Staphylococcus aureus.

Yeasts:

Candida such as Candida albicans, Geotrichum such as Geotrichum candidum, Rhodotorula such as Rhodotorula rubra, Rhodotorula mucilaginosa, Saccharomyces such as Saccharomyces cerevisiae.

Fungi:

Acremonium such as Acremonium strictum, Alternaria such as Alternaria tenuis or Alternaria alternata, Aspergillus such as Aspergillus niger, Chaetomium such as Chaetomium globosum, Fusarium such as Fusarium solari, Lentinus such as Lentinus tigrinus, Paecilomyces such as Paecilomyces variotti, Penicillium such as Penicillium glaucum, Trichoderma such as Trichoderma viride.

The examples which follow document by way of example but without limitation the surprising activity enhancement of the composition according to the invention.

### EXAMPLES

The synergism of the composition according to the invention is demonstrated hereinbelow by way of example against certain pathogens that are particularly relevant in practice, for example Pseudomonas aeruginosa, Staphylococcus aureus, Alternaria alternata or Geotrichum candidum.

The observed synergism of the compositions according to the invention may be determined by the following mathematical formula (cf. F. C. Kull, P. C. Elisman, H. D. Sylwestrowicz, P. K. Mayer, Appl. Microbiol. 9, 1961, page 538:

$$synergistic index ( S I ) = \frac{{Q}_{a}}{{Q}_{A}} + \frac{{Q}_{b}}{{Q}_{B}}$$

where:
Qₐ=the amount of component A in the active substance mixture which achieves the desired effect, i.e. no microbial growth,
Q_{A}=the amount of component A which, when used on its own, suppresses the growth of the microorganisms,
Q_{b}=the amount of component B in the active substance mixture which achieves the desired effect, i.e. no microbial growth,
and
Q_{B}=the amount of component B which, when used on its own, suppresses the growth of the microorganisms.

A synergistic index obtained according to the above formula of SI<1 indicates a synergistic effect for the active substance mixture. The smaller the SI, the greater the synergistic effect.

The synergistic activity enhancement is elucidated by way of example but not by way of limitation with reference to the examples and calculations which follow.

### Example 1

Using various test pathogens, the minimum inhibitory concentration was determined and, on the basis thereof with the aid of the formula by F. C. Kull et al., the synergistic effects of the listed compositions according to the invention were calculated.

Compositions Comprising DBDCB and Citric Acid

TABLE 1
(test pathogen: Staphylococcus aureus):

| | DBDCB:citric | | | |
|---|---|---|---|---|
| | acid | | | |
| No. | [wt %/wt %] | Qₐ DBDCB [ppm] | Q_{b} citric acid [ppm] | SI |
| 1 | 9:1 | 45 | 5 | 0.90 |
| 2 | 8:2 | 40 | 10 | 0.80 |
| 3 | 7:3 | 35 | 15 | 0.70 |

(test pathogen: Staphylococcus aureus => Q_{A} = 50 ppm of DBDCB, Q_{B} = 3001 ppm or citric acid)

In certain concentration ratios, the inventive compositions show a distinct synergistic effect against the test pathogen Staphylococcus aureus.

TABLE 2
(test pathogen: Alternaria alternata):

| | DBDCB:citric | | | |
|---|---|---|---|---|
| | acid | | | |
| No. | [wt %/wt %] | Qₐ DBDCB [ppm] | Q_{b} citric acid [ppm] | SI |
| 1 | 9:1 | 22.5 | 2.5 | 0.90 |
| 2 | 8:2 | 20 | 5 | 0.80 |
| 3 | 7:3 | 17.5 | 7.5 | 0.70 |

(test pathogen: Alternaria alternata => Q_{A} = 25 ppm of DBDCB, Q_{B} = 3001 ppm of citric acid)

In certain concentration ratios, the inventive compositions show a distinct synergistic effect against the test pathogen Alternaria alternata.

TABLE 3
(test pathogen: Geotrichum candidum):

| | DBDCB:citric | | | |
|---|---|---|---|---|
| | acid | | | |
| No. | [wt %/wt %] | Qₐ DBDCB [ppm] | Q_{b} citric acid [ppm] | SI |
| 1 | 9:1 | 90 | 10 | 0.90 |
| 2 | 8:2 | 80 | 20 | 0.81 |
| 3 | 7:3 | 35 | 15 | 0.35 |

(test pathogen: Geotrichum candidum => Q_{A} = 100 ppm of DBDCB, Q_{B} = 3001 ppm of citric acid)

In certain concentration ratios, the inventive compositions show a distinct synergistic effect against the test pathogen Geotrichum candidum.

Compositions comprising DBDCB and Lactic Acid

TABLE 4
(test pathogen: Pseudomonas aeruginosa):

| | DBDCB:lactic | | | |
|---|---|---|---|---|
| | acid | | | |
| No. | [wt %/wt %] | Qₐ DBDCB [ppm] | Q_{b} lactic acid [ppm] | SI |
| 1 | 9:1 | 450 | 50 | 0.92 |
| 2 | 8:2 | 400 | 100 | 0.83 |
| 3 | 7:3 | 350 | 150 | 0.75 |
| 4 | 6:4 | 300 | 200 | 0.67 |

(test pathogen: Pseudomonas aeruginosa => Q_{A} = 500 ppm of DBDCB, Q_{B} = 3001 ppm of lactic acid)

In certain concentration ratios, the inventive compositions show a distinct synergistic effect against the test pathogen Pseudomonas aeruginosa.

TABLE 5
(test pathogen: Alternaria alternata):

| | DBDCB:lactic | | | |
|---|---|---|---|---|
| | acid | | | |
| No. | [wt %/wt %] | Qₐ DBDCB [ppm] | Q_{b} lactic acid [ppm] | SI |
| 1 | 9:1 | 22.5 | 2.5 | 0.90 |
| 2 | 8:2 | 20 | 5 | 0.80 |
| 3 | 7:3 | 17.5 | 7.5 | 0.70 |
| 4 | 6:4 | 15 | 10 | 0.60 |
| 5 | 5:5 | 12.5 | 12.5 | 0.50 |
| 6 | 4:6 | 10 | 15 | 0.40 |
| 7 | 3:7 | 15 | 35 | 0.61 |
| 8 | 2:8 | 15 | 60 | 0.62 |
| 9 | 1:9 | 10 | 90 | 0.43 |

(test pathogen: Alternaria alternata => Q_{A} = 25 ppm of DBDCB, Q_{B} = 3001 ppm of lactic acid)

In certain concentration ratios, the inventive compositions show a distinct synergistic effect against the test pathogen Alternaria alternata.

Compositions Comprising DBDCB and Salicylic Acid

TABLE 6
(test pathogen: Pseudomonas aeruginosa):

| | DBDCB:salicylic | | | |
|---|---|---|---|---|
| | acid | | Q_{b} salicylic acid | |
| No. | [wt %/wt %] | Qₐ DBDCB [ppm] | [ppm] | SI |
| 1 | 9:1 | 225 | 25 | 0.91 |
| 2 | 8:2 | 200 | 50 | 0.82 |
| 3 | 7:3 | 175 | 75 | 0.72 |
| 4 | 6:4 | 150 | 100 | 0.63 |
| 5 | 4:6 | 200 | 300 | 0.90 |
| 6 | 3:7 | 150 | 350 | 0.72 |

(test pathogen: Pseudomonas aeruginosa Q_{A} = 250 ppm of DBDCB, Q_{B} = 3001 ppm of salicylic acid)

In certain concentration ratios, the inventive compositions show a distinct synergistic effect against the test pathogen Pseudomonas aeruginosa.

TABLE 7
(test pathogen: Alternaria alternata):

| | DBDCB:salicylic | | | |
|---|---|---|---|---|
| | acid | | Q_{b} salicylic acid | |
| No. | [wt %/wt %] | Qₐ DBDCB [ppm] | [ppm] | SI |
| 1 | 9:1 | 22.5 | 2.5 | 0.91 |
| 2 | 8:2 | 20 | 5 | 0.81 |
| 3 | 7:3 | 17.5 | 7.5 | 0.72 |
| 4 | 4:6 | 20 | 30 | 0.86 |
| 5 | 3:7 | 15 | 35 | 0.87 |
| 6 | 2:8 | 15 | 60 | 0.72 |

(test pathogen: Alternaria alternate => Q_{A} = 25 ppm of DBDCB, Q_{B} = 500 ppm of salicylic acid)

In certain concentration ratios, the inventive compositions show a distinct synergistic effect against the test pathogen Alternaria alternata.

Compositions Comprising DBDCB and Benzoic Acid

TABLE 8
(test pathogen: Bacillus subtilis):

| | DBDCB:benzoic | | | |
|---|---|---|---|---|
| | acid | | Q_{b} benzoic acid | |
| No. | [wt %/wt %] | Qₐ DBDCB [ppm] | [ppm] | SI |
| 1 | 9:1 | 22.5 | 2.5 | 0.90 |
| 2 | 8:2 | 20 | 5 | 0.80 |
| 3 | 7:3 | 17.5 | 7.5 | 0.70 |
| 4 | 6:4 | 22.5 | 15 | 0.91 |
| 5 | 5:5 | 25 | 25 | 1.01 |
| 6 | 4:6 | 20 | 30 | 0.81 |
| 7 | 3:7 | 15 | 35 | 0.61 |
| 8 | 2:8 | 20 | 80 | 0.83 |

(Q_{A} = 25 ppm of DBDCB, Q_{B} = 3000 ppm of benzoic acid)

In certain concentration ratios, the inventive compositions show a distinct synergistic effect against the test pathogen Bacillus subtilis.

TABLE 9
(test pathogen: Aspergillus brasiliensis):

| | DBDCB:benzoic | | | |
|---|---|---|---|---|
| | acid | | Q_{b} benzoic acid | |
| No. | [wt %/wt %] | Qₐ DBDCB [ppm] | [ppm] | SI |
| 1 | 9:1 | 225 | 25 | 0.93 |
| 2 | 8:2 | 200 | 50 | 0.85 |
| 3 | 7:3 | 175 | 75 | 0.78 |
| 4 | 6:4 | 150 | 100 | 0.70 |
| 5 | 5:5 | 125 | 125 | 0.63 |
| 6 | 4:6 | 100 | 150 | 0.55 |
| 7 | 3:7 | 150 | 350 | 0.95 |
| 8 | 2:8 | 100 | 400 | 0.80 |
| 9 | 1:9 | 50 | 450 | 0.65 |

(Q_{A} = 250 ppm of DBDCB, Q_{B} = 1000 ppm of benzoic acid)

In certain concentration ratios, the inventive compositions show a distinct synergistic effect against the test pathogen Aspergillus brasillensis.

### Example 2: Microbiological Load Test—Preservation of a Dishwashing Liquid

The preserving effect of an inventive composition comprising DBDCB and Salix alba extract in a dishwashing liquid was investigated using a microbiological load test.

The microbiological load test examines the susceptibility of water-based products to microbial attack and the effect of preservatives. To this end, the preservatives are incorporated in defined concentrations into the water-based systems. After the preparations have been completed, repeated contamination with microorganisms of a defined species and in defined amounts is effected at weekly intervals over a test period of 3 to not more than 6 weeks. 2-3 days and 7 days after each contamination, microbial count is determined to establish whether complete elimination or at least inhibition of propagation of the introduced microorganisms compared to the unpreserved control sample has been achieved.

With knowledge of the microorganism populations prevalent in detergents of the type described here, the experiment employed a mixture of the following microorganism species for testing:

Bacteria: Escherichia coil, Pseudomonas aeruginosa, Staphylococcus aureus, Pseudomonas putida, Enterobacter gergoviae

Molds: Acremonium strictum, Aspergillus niger and Geotrichum candidum.

Yeasts: Candida albicans and Rhodotorula rubra.

Very good activity is achieved when there is complete elimination (0 bacteria/mold cells/yeast cells per g) of the introduced microorganisms in the preserved samples (score of 3=very good).

The activity is deemed good when a markedly reduced microbe level is observed (10³-10¹ bacteria/10²-10¹ mold cells/yeast cells per g) in the preserved samples compared to the unpreserved sample (so-called reference sample) (score of 2=good).

The activity is deemed fair when, compared to the unpreserved sample, a mildly reduced microbe level is observed (10⁴-10³ bacteria/10³-10² mold cells/yeast cells per g) (score of 1=fair).

The activity is deemed poor when, compared to the unpreserved sample, no reduction or only a minor reduction of the microbe level is observed (residual level of at least 10⁵ bacteria/10⁴ mold cells/yeast cells per g) (score of 0=poor). The results achieved are shown in table 10.

The following compositions were used in the experiments depicted in table 10:
A: DBDCB
B: Composition comprising 25 wt % of Salix alba extract (comprising 80 wt % of salicylic acid) and 75 wt % of 1,2-propanediol.
C: Composition comprising 20 wt % of DBDCB, 20 wt % of Salix alba extract (comprising 80 wt % of salicylic acid) and 60 wt % of 1,2-propanediol (inventive).

TABLE 10
Activity of the biocides in a dishwashing liquid, determined
in each case 1 week after pathogen addition

| | Biocide | | | | | | | |
|---|---|---|---|---|---|---|---|---|
| Composition | added | | Week | | | | | |
| used | [wt %] | | 1 | 2 | 3 | 4 | 5 | 6 |
| A | DBDCB [0.05] | B | 1 | 0 | 0 | 0 | 0 | 0 |
| | | M | 3 | 3 | 0 | 0 | 0 | 0 |
| | | Y | 3 | 3 | 0 | 0 | 0 | 0 |
| B | Salicylic acid | B | 1 | 0 | 0 | 0 | 0 | 0 |
| | [0.02] | M | 1 | 1 | 0 | 0 | 0 | 0 |
| | | Y | 1 | 0 | 0 | 0 | 0 | 0 |
| C | DBDCB [0.02] | B | 3 | 3 | 3 | 3 | 3 | 3 |
| | and | M | 1 | 3 | 3 | 3 | 3 | 3 |
| | salicylic acid | Y | 3 | 3 | 3 | 3 | 3 | 3 |
| | [0.016] | | | | | | | |

(B = bacteria, M = molds, Y = yeasts)
3 = very good activity
2 = good activity
1 = fair activity
0 = poor activity

Adding an inventive composition comprising DBDCB and Salix alba extract comprising 80 wt % of salicylic acid achieves very good preservation activity despite a markedly reduced amount of active substance compared to the individual active substance DBDCB, i.e. all microorganism species used for testing are eliminated by the inventive mixture.

1. A biocidal composition comprising:
1,2-dibromo-2,4-dicyanobutane (DBDCB); and
an organic acid and/or an organic acid derivative.

2. The composition as claimed in claim 1, wherein a weight ratio of the DBDCB to the organic acid and/or the organic acid derivative is 99:1 to 1:99.

3. The composition as claimed in claim 1, wherein the organic acid and/or the organic acid derivative is selected from the group consisting of mono- and polycarboxylic acids and the derivatives thereof.

4. The composition as claimed in claim 1, wherein the organic acid and/or the organic acid derivative is salicylic acid and/or the derivatives thereof and is in the form of a composition SA which comprises at least 10 wt %, based on the total weight of the composition SA, of salicylic acid and/or the derivatives thereof.

5. The composition as claimed in claim 4, wherein the composition SA is a Salix alba extract.

6. The composition as claimed in claim 5, wherein the Salix alba extract is an extract from the bark of the white willow.

7. The composition as claimed in claim 1, further comprising at least one further biocidal active substance.

8. The composition as claimed in claim 1, wherein the sum of the weights of DBDCB, of the at least one organic acid and/or the derivative thereof, and of the additionally no further biocidal active substance or at least one further biocidal active substance is 1 to 80 wt %, preferably 5 to 60 wt % of the total weight of the composition.

9. The composition as claimed in claim 1, the organic acid derivatives are alkali metal salts of organic acids, preferably selected from the group consisting of sodium, potassium and lithium salts.

10. The composition as claimed in claim 1, further comprising at least one further added substance selected from the group consisting of surface-active substances, wetting agents, emulsifiers, dispersants, stabilizers, adhesives, thickeners, spreading agents, organic solvents, fragrances, colorants, antidusting agents, buffering substances, buffer systems, pH regulators, solid carriers and water, particularly preferably at least one organic solvent, very particularly preferably at least one glycol.

11. The composition as claimed in 10, wherein the composition comprises 20 to 99 wt %, preferably 40 to 95 wt %, of the at least one further added substance, based on the total weight of the composition.

12. A process for producing the composition as claimed in claim 1, the process comprising mixing the DBDCB and the organic acid and/or organic acid derivative, optionally with addition of at least one further biocidal active substance and optionally with addition of at least one further added substance.

13. A method for protection of industrial materials from attack and/or destruction by microorganisms, the method comprising treating the industrial materials with the composition as claimed in claim 1.

14. An industrial material treated with the composition as claimed in claim 1.

15. An industrial material comprising a composition as claimed in claim 1.

16. The composition as claimed in claim 1, wherein a weight ratio of the DBDCB to the organic acid and/or organic acid derivatives is 9:1 to 1:9.

17. The composition as claimed in claim 1, wherein the organic acid and/or organic acid derivative is selected from the group consisting of benzoic acid, lactic acid, salicylic acid, sorbic acid, citric acid, and the derivatives thereof.

18. The composition as claimed in claim 1, wherein the organic acid and/or organic acid derivative is salicylic acid and/or the derivatives thereof and is in the form of a composition SA which comprises at least 75 wt %, based on the total weight of the composition SA, of salicylic acid and/or the derivative thereof.

19. The composition as claimed in claim 18, wherein the composition SA is a Salix alba extract from the bark of the white willow, extracted with water and/or ethanol.

20. The composition as claimed in claim 1, wherein:
a weight ratio of the DBDCB to the organic add and/or the organic acid derivative is 9:1 to 1:9;
the organic acid and/or the organic acid derivative is salicylic acid and/or derivatives thereof and is in the form of a composition SA which comprises a Salix alba extract from the bark of the white willow, wherein the Salix alba extract comprises at least 50 wt %, based on the total weight of the composition SA, of the salicylic acid and/or the derivatives thereof;
the composition further comprises at least one further biocidal active substance selected from the group consisting of 1,2-benzisothiazol-3(2H)-one (BIT), benzyl alcohol, benzyl hemiformal, 2-bromo-2-nitropropane-1,3-diol (Bronopol), 5-chloro-2-methyl-4-isothiazolin-3-one/2-methyl-4-isothiazolin-3-one (CMIT/MIT), 2,2-dibromo-3-nitrilopropionamide (DBNPA), diazolidinyl urea, 3,3-dimethylol-5,5-dimethylhydantoin (DMDMH), dichlorobenzyl alcohol, didecyldimethylammonium chloride, dimethylolhydantoin, dodecylguanidine hydrochloride, imidazolidinyl urea, iodopropargyl butylcarbamate (IPBC), 2-n-octylisothiazolin-3-one (OIT), phenoxyethanol, phenoxypropanol, phenylethyl alcohol, o-phenylphenol (OPP), poly(hexamethylenebiguanide) hydrochloride (PHMB), tetramethylolacetylene diurea (TMAD);
the weight ratio of the at least one further biocidal active substance to the sum of DBDCB and the organic acid and/or the organic acid derivative is 1:40 to 1:1;
the sum of the weights of DBDCB, of the at least one organic acid and/or the derivative, and of at least one further biocidal active substance is 5 to 60 wt of the total weight of the composition;
the organic acid derivatives are alkali metal salts of organic acids selected from the group consisting of sodium, potassium and lithium salts; and
the composition additionally comprises, based on the total weight of the composition, 40 to 95 wt % of at least one glycol.
